(19) United States
(12) Patent Application Publication
(10) Pub. No.: US 2004/0216373 A1
(43) Pub. Date: Nov. 4, 2004

(54) Water garden pond having a flexible side wall

(76) Inventor: James T. Kindley, Dallas, TX (US)

Correspondence Address: CARR LAW FIRM, L.L.P., 670 FOUNDERS SQUARE, 900 JACKSON STREET, DALLAS, TX, 75202, US

(21) Appl. No.: 10/410,708

(22) Filed: Apr. 9, 2003

(51) Int. Cl. A01G 31/00

(52) U.S. Cl. 47/59 R

(57) ABSTRACT

A decorative pond having a bottom and a soft and flexible side wall extending up from the bottom and forming an interior section for containing a liquid such as water. The side wall deforms outwardly near the bottom when the pond is filled with water, providing an attractive curved shape to the pond. The side wall may be fabricated from a polymer such as polyvinyl chloride and may be translucent or transparent. The decorative pond can be installed quickly and easily with no digging or complicated plumbing. The decorative pond is portable and safe, providing an attractive environment for aquatic plants and certain fish.

### TECHNICAL FIELD

The invention relates generally to water gardens and, more particularly, to decorative vessels for containing a water garden, pond and the like.

### BACKGROUND

Water gardening is a fast-growing segment of lawn and garden retail merchandising. A typical water garden is formed by a container or vessel, suitable for filling with water or other liquids to form a pool, pond, or the like. In addition to holding water and other liquids, water gardens often also contain one or more varieties of aquatic plants and/or animals, such as anacharis, lotus, water lilies, and fish.

In the past, water garden vessels and containers have been fabricated from a rigid material forming a structure that is large, awkward, and expensive to manufacture and transport. A specific supporting structure is frequently also required for above-ground use. Alternatively, a specific excavation combined with supporting structure is often required for in-ground use.

Another typical water garden container or vessel frequently encountered is fabricated from an inexpensive material for lining a hole dug into the ground. Digging a hole into the ground is a labor-intensive process that is difficult to perform, especially if specific excavation requirements must be satisfied.

Therefore, a need exists for a method and apparatus for installing a water garden pond without incurring one or more of the disadvantages of labor, time, expense, awkwardness of handling, excavation, material costs and support structures associated with traditional water garden structures.

### SUMMARY

The present invention achieves these and other objectives using a pond container having a bottom and a flexible side wall, extending generally upward from a bottom surface, together forming a container for a liquid such as water. The pond container provides an attractive environment for aquatic plants and certain fish.

In one aspect of the invention, the container bottom and side wall is formed of material that is flexible or foldable in at least two dimensions, allowing the container to be folded for packaging, storage or transport.

In yet another aspect of the invention, pressure from liquid held by the pond container provides support to the container side wall.

In another aspect of the invention, the container side wall is fabricated from a flexible material which deforms or expands outwardly from its unfilled form when filled with a liquid such as water.

In another aspect of the invention, at least a portion of the side wall is a deformable material that responds to head pressure of liquid within the container by outwardly expanding into a curved shape.

In still another aspect of the invention, the head pressure gradient of liquid within the pond container outwardly expands at least a portion of the side wall into a curvature of varying radius.

In another aspect of the invention, at least a portion of the side wall is fabricated from a translucent or substantially clear material, producing aesthetically pleasing images of one or more light reflections, light refractions and shadows from within the pond container.

In another aspect of the invention, the flexible side wall is soft and fabricated from a substantially transparent polymer, providing an attractive view of the interior and contents of the decorative pond.

In another aspect of the invention, a submersible water pump provides water circulation and aeration of the pond. The pump may also be configured as a fountain in the pond.

In yet another aspect of the invention, the decorative pond has one or more retainers or fasteners attached to the side wall for securing one or both of a water pump outlet spout and a water pump power cord.

In still another aspect of the invention, the pond is provided with a relatively more rigid liner inserted onto or forming at least a portion of the bottom of the pond container. In one embodiment, at least a portion of the liner is supported above the container bottom to provide a space for secluding at least a portion of a pump or other circulation equipment from view.

In still another aspect of the invention, the liner bears one or more images or designs.

### BRIEF DESCRIPTION OF THE DRAWINGS

For a more complete understanding of the pond container, and the advantages thereof, reference is now made to the following descriptions taken in conjunction with the accompanying drawings, in which:

FIG. 1 is a perspective view of an embodiment of a pond container;

FIG. 2 is a perspective view of the pond container of FIG. 1 containing water to form a pond;

FIG. 3A is a cross-section of the pond container, taken along line 3-3 of FIG. 2;

FIG. 3B is a detail of the cross-section of FIG. 3A;

FIG. 4 is a perspective view of a pond container embodying additional features;

FIG. 5 is a cross-section of a pond container, taken along line 5-5 of FIG. 4;

FIGS. 6 and 7A are perspective views of pond containers embodying additional features;

FIG. 7B is a cross-section of a pond container, of taken along line 7B-7B of FIG. 7A;

FIGS. 8 and 8A are perspective views of a pond container embodying additional features;

FIG. 9 is a flow chart depicting steps performed to fabricate one embodiment of a pond container;

FIG. 10 is a flow chart depicting alternative steps performed to fabricate an additional embodiment of a pond container; and

FIGS. 11A-11E are perspective views showing a method of folding and rolling a pond container.

### DETAILED DESCRIPTION

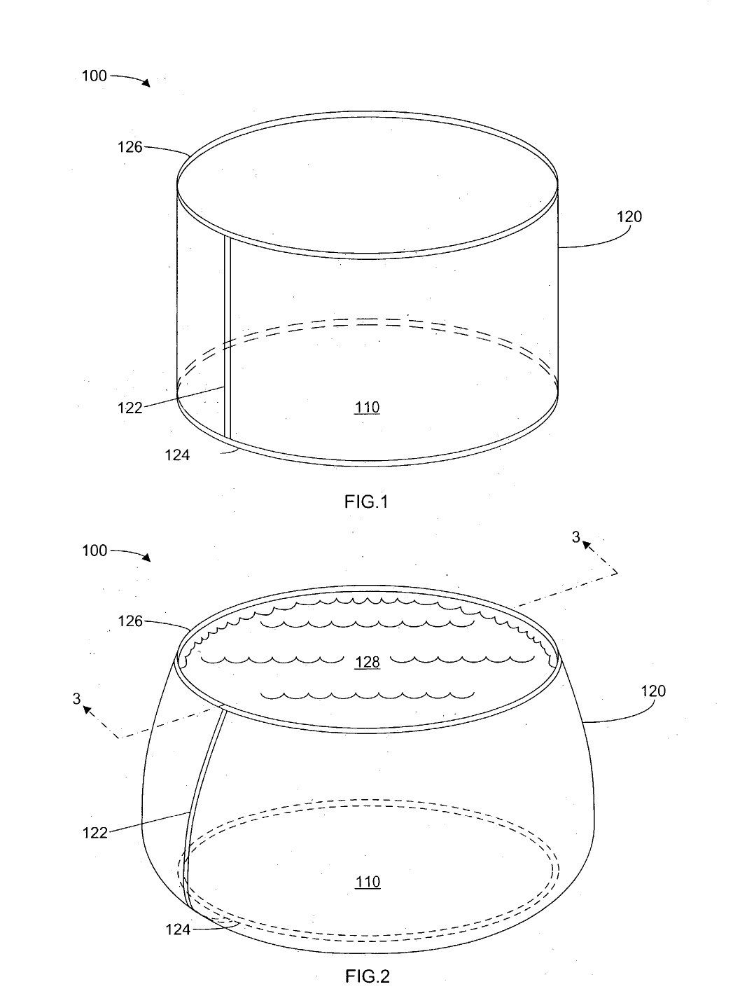

Referring to FIG. 1 of the drawings, the reference numeral 100 generally designates a vessel for containing a liquid such as water, to form a pond, pool, or the like, and referred to hereinafter as a pond container 100. The pond container 100 has a bottom 110, which is preferably circular, but which may be any shape, such as rectangular, elliptical, or an irregular shape. The pond container 100 also includes a side wall 120 extending generally upwards from the bottom 110. The side wall 120 is preferably fabricated from an elongated strip of material joined end-to-end at a first seam 122 to form a right cylinder. Alternatively, the side wall may be any other shape, such as conical, rectangular, or an irregular shape. The lower edge of side wall 120 is connected to the bottom 110 along a second seam 124 at or near the perimeter of the bottom 110, to form a water-tight seal. A top edge 126 of the side wall 120 is preferably trimmed with additional material similar to that of side wall 120.

The side wall 120 and bottom 110 of the pond container 100 are preferably fabricated from a soft and flexible heavy-duty polymer such as polyvinyl chloride (PVC, or vinyl), although any material may be used which are effective for containing water, flexible and weather-resistant. PVC is one of the most widely used polymers in the world. PVC is usually plasticized with low or medium molecular weight materials. The properties of PVC (vinyl) can be finely tuned by those skilled in the art from rigid to soft and flexible by varying the plasticizer content from a few percent to more than sixty percent. Although the largest use of PVC is for rigid pipe, flexible formulations of PVC are widely used in flooring and medical products and are readily available. PVC used to fabricate the pond container 100 can be varied from clear to translucent, to opaque, both with and without coloration, depending upon the formulation of the chemical mixture from which the vinyl material is fabricated.

In the embodiment shown in FIG. 2, the side wall 120 is fabricated from flexible PVC material approximately 0.9 mm (0.035 inches) thick that is either translucent or substantially transparent (clear). The material is preferably soft in the sense of deforming or conforming to the form or surface applying a pressure or force against its surface. This sort of deformation results from the material being foldable along at least two perpendicular directions and preferably in any direction, without permanent deformation, creasing, cracking or breaking. It should be noted that the side wall 120 material may retain fold lines or marks for some period of time after being unfolded without adversely affecting structural or functional performance. The material allows the side wall 120 to deform into a curved shape under fluid pressure from within the container 100, somewhat like the surface of a balloon. The material is preferably capable of being stretched without breaking under the pressure of liquid 128 forming a pond within the container 100, thus allowing the side wall 120 to bulge outwardly to a greater extent as the head pressure of the liquid 128 increases with the depth of the container 100. The side wall 120 material is preferably flexible in the sense that it can be folded without cracking or breaking.

The bottom 110 is preferably fabricated from a flexible PVC material approximately 0.3 mm (0.012 inches). The bottom seam 124 and the top edge trim 126 are shown fabricated from a vinyl material that is flexible and opaque, and are preferably joined using a heat-seal process. Alternatively, the seams may be joined using a sonic weld, an adhesive or any other process that is effective in creating a water-tight seal. To provide added variety, the side wall 120, bottom 110, bottom seam 124 and/or trim 126 can be fabricated of flexible material ranging from opaque to translucent to clear (substantially transparent).

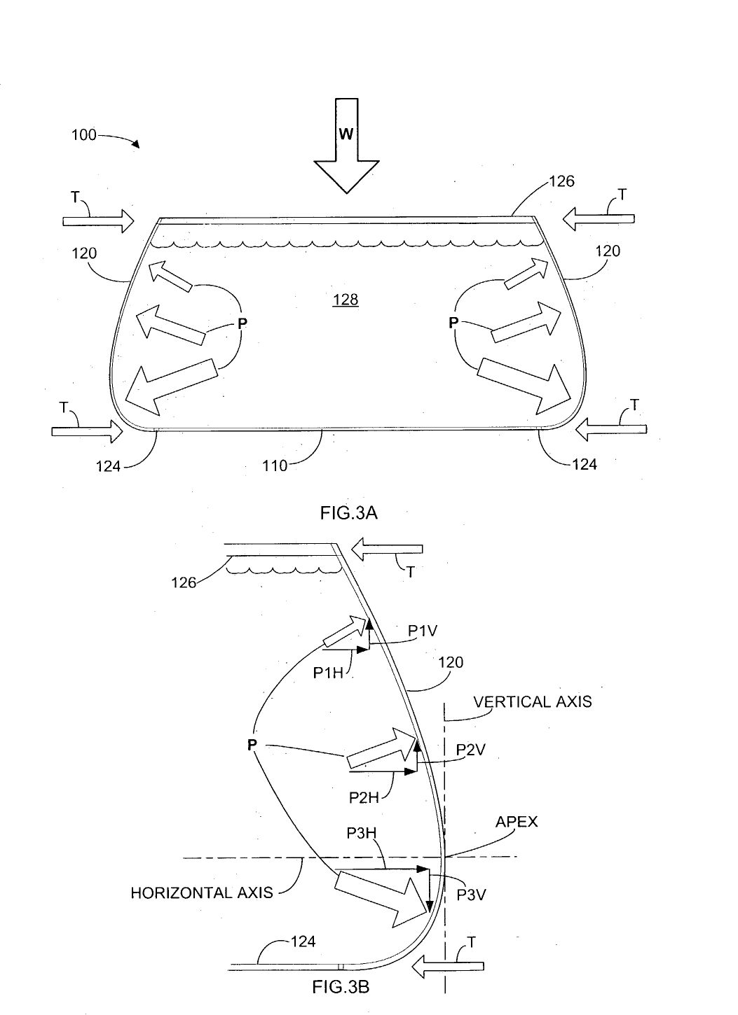

As shown in FIGS. 2, 3A and 3B, the preferably nominally cylindrical wall 120 preferably assumes an outwardly curved shape when the pond container 100 is filled with water 128. Referring to FIG. 3A, the weight W of the water exerts a head pressure P on the wall 120 and causes the pond container 100 to distend into a continuously curved shape, of which the curve radius decreases as the curve approaches the bottom of the container 100. The side wall 120 bulges outwardly to a greater extent as the head pressure P of the liquid 128 increases with the depth of the container 100. The outward bulge then dissipates gradually near the bottom 110 of the container 100 in response to an inwardly directed tensile force T caused by tension of the bottom 110 against the seam 124 joining it to the lower reaches of the side wall 120. In the embodiment shown, the bulge of the side wall 120 dissipates more quickly as the bottom 110 is approached than toward the top edge trim 126 of the container 100. Such tension T tends to limit or reduce the expansion and resulting bulge of the side wall 120 nearer to the seam 124 joining the side wall to the bottom 110.

The side wall 120 is supported by outward pressure P of, the liquid 128 within the container. As the side wall 120 expands outwardly in response to head pressure P from the liquid 128 held by the container 100, the side wall 120 inner surface faces more downwardly from the horizontal than when the container 100 is unfilled. This results in part from increasing head pressure P and the resulting increasingly outward expansion of the side wall 110 as the depth of the liquid increases. Relatively uniform thickness of the material comprising the side wall 120, and thus relatively uniform elasticity and spring constant of the side wall 120, contribute to this effect. Although uniform thickness and elasticity of the side wall 120 material is preferred, it will be apparent that variation of the elasticity, thickness or spring constant of the side wall 120 in a vertical direction can be used to adjust the degree to which the inner surface of the side wall 120 faces more downwardly when the container holds liquid 128 and can produce variation in the outward curvature or bulge of the side wall 120. In addition, variation of the thickness, elasticity or spring constant of the side wall 120 in a horizontal direction can produce a variation in the curvature or overall shape of the container 100 when filled, such as producing a ridged, scalloped or irregular shape.

Referring to FIG. 3B, head pressure P from the water or other liquid acts in a direction normal to the side wall 120 surfaces. A vertical component P1V, P2V of the pressure P acting upwardly against the downwardly facing inner surfaces supports the side wall 120 vertically.

A component P3H of head pressure P against the lower portion of the side wall 120 near the bottom 110 stretches outwardly from and over the bottom seam 124, preferably hiding the second seam 124 from view.

As shown in FIG. 3B, head pressure P acting upon the side wall 120 produces a outward expansion of the side wall 120, restrained by the inwardly-directed tensile forces T, and forms a bulge in the side wall having an Apex, indicated at an intersection of a Vertical Axis and a Horizontal Axis, near the bottom 110 of the container 100.

The particular shape assumed by the pond container 100 may vary depending upon the diameter and depth of the pond, the water level, and/or the thickness or other properties of the side wall material.

The pond container 100 may be constructed so as to form other shapes besides a cylinder. In such cases, the material used is preferably flexible, such that the side wall 120 deforms outwardly to a greater extent near the bottom 110 than nearer the upper edge of the side wall 120. At least a portion of the side wall 120 is preferably supported at least in part by an upwardly directed component of the head pressure P exerted by the contained liquid. This can be accomplished by configuring the container 100 side wall 120 such that at least a portion of their inner surfaces face downwardly from the horizontal.

For example, the side wall 120 may be constructed to form an initial conical or other shape when the container 100 is open and empty. When the container 100 is filled with water, the side wall 120 preferably expands outwardly nearer the bottom 110 and the inner surfaces of the side wall 120 face downwardly from the horizontal to a greater extent than the right cylindrical form shown in FIG. 1, for example. The initial conical configuration thus increases the vertically supporting force imported to the side wall 120 by the head pressure P of liquid within the container 100.

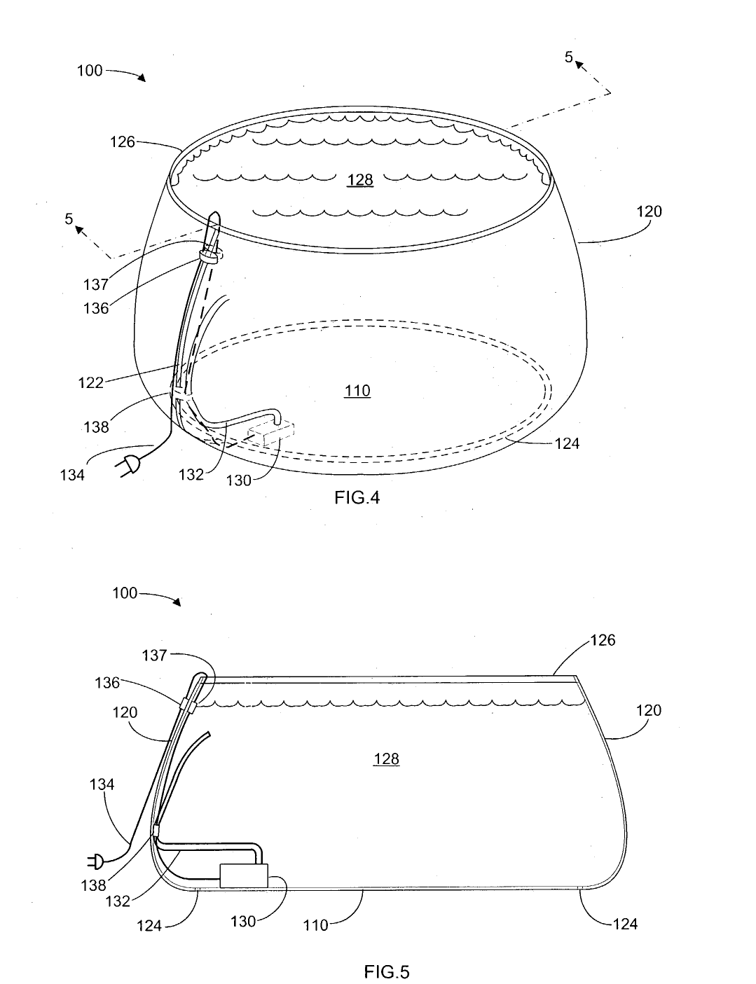

FIGS. 4 and 5 depict the container 100 provided with a submersible water pump 130 having an outlet spout 132 for water circulation and aeration. Referring to FIG. 4, retainers such as tabs, loops, clips or the like (collectively referred to hereinafter as “tabs”) 136-138 are preferably attached to the side wall 120 at the first seam 122. The tabs 136-138 are preferably fabricated from the same vinyl material as the seam 124 and are preferably joined with the seam 122 using a heat-seal process, sonic weld, an adhesive or the like to form loops through which a spout or cord may be passed. A first tab 136 is joined at the first seam 122 on the outside of the side wall 120. A second tab 137 is joined at seam 122 on the inside of side wall 120, preferably opposite the first tab 136. A third tab 138 is joined at seam 122 on the inside of side wall 120, preferably below the second tab 137.

As shown in FIG. 5, the submersible water pump 130 is placed on the bottom 110 of the pond container 100 to provide water circulation and aeration. The pump 130 is preferably electrically operated and has a power cord 134 for connection to a source of electrical power. The pump 130 has an outlet fitted with a spout 132 for directing the flow of water. The spout 132 is preferably made from a section of flexible tubing.

The power cord 134 is preferably routed up the inside of the pond container 100 by passing the cord through tabs 138 and 137, over the top edge trim 126, and down the outside of the pond container 100 through tab 136. The outlet spout 132 is preferably routed through one (as shown) or both tabs 138, 137 as desired for directing the flow of water. Circulation of the water may be obtained by routing the outlet spout 132 through lower tab 138. A water fountain may be created by further routing the outlet spout 132 through upper tab 137.

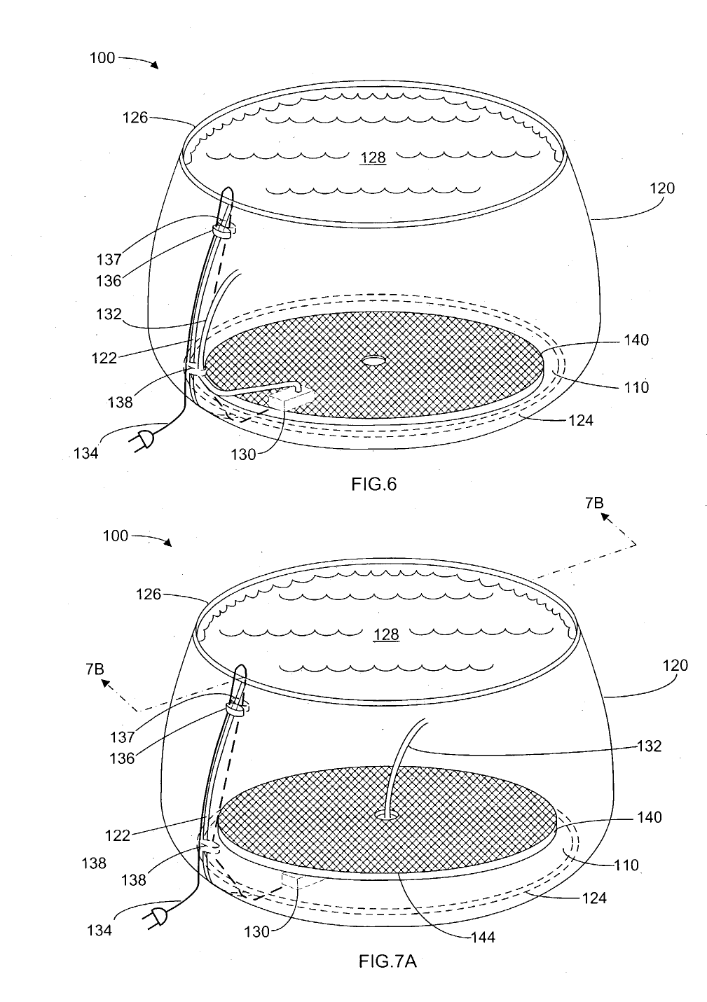

FIG. 6 depicts a water garden pond provided with a decorative liner 140 such as the decorative liner described in co-pending U.S. patent application Ser. No. 09/923,003 filed on Aug. 3, 2001, or in co-pending U.S. patent application Ser. No. 10/287,309 filed on Nov. 4, 2002. The disclosure of both of the foregoing patent applications is incorporated herein by reference for all purposes. The decorative liner 140 is preferably a single piece fabricated from a rigid plastic material, having one or more display surfaces on the liner, and molded to have one or more distinct raised portions (shown by grid lines) formed in the shape of one or more tiles on the one or more display surfaces. The decorative liner 140 as shown in FIG. 6 rests on the bottom 110 of the pond container 100, and presents the appearance of a mosaic tile pattern. The submersible water pump 130 is preferably placed on top of the decorative liner 140.

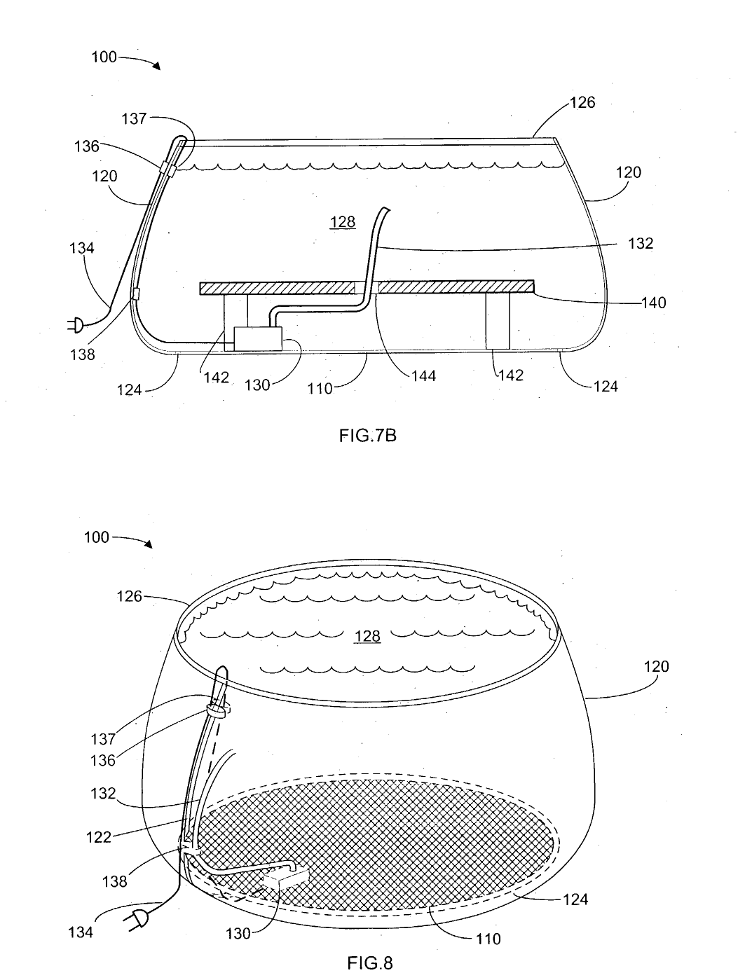

FIGS. 7A and 7B depict an alternate arrangement of a water garden pond provided with a decorative liner 140, in which the liner 140 is raised above the bottom 110 and shelters the pump 130 from view and from harm. A support, such as a number of blocks 142 (FIG. 7B) or other such support arrangement, rests on the bottom 110 and the decorative liner 140 rests on the support arrangement. Alternatively, a support structure (not shown) can be built into the liner 140 itself. The submersible water pump 130 is placed on the bottom 110, and below the decorative liner 140, with the outlet spout 132 extending upwardly through a hole 144 defined in the center of the decorative liner 140.

FIG. 8 depicts an alternate embodiment of the decorative pond container 100 wherein a decorative mosaic tile pattern (shown by grid lines) is printed on the bottom 110 to further enhance the appearance of the container 100 and pond. Designs representing a mosaic tile pattern or some other decorative image can be applied to the bottom 110 using a silk-screen or other process during manufacture of the container 100 or thereafter. The bottom 110 can alternatively be fabricated from a rigid material, such as a rigid plastic, or a semi-rigid material, such as a semi-rigid polymer formulation, and used together with a flexible material for the side wall 120. Additional or alternative designs can also be applied to the side wall 120 using a silk-screen or other process as desired. The use of pre-printed designs, such as a mosaic tile pattern on the bottom 110 and/or representations of plants and/or fish on the side wall 120, further simplifies initial set up of the container 100 and decorative pond, simulating the effect of a complete water garden with or without the presence of any actual plants and/or fish.

FIG. 8A depicts a typical water garden comprising the pond container 100 and an aquatic plant 802 growing in a submerged flower pot 804. The side wall 120 is fabricated from a translucent, flexible material such as a flexible PVC formulation as described in reference to FIG. 2 above. A shadow 806 of the plant 802 is cast upon the translucent side wall 120 and appears from the exterior of the pond container. Another shadow 808 may appear on another area of the side wall 120, depending upon the angle of view and the angle of incident illumination.

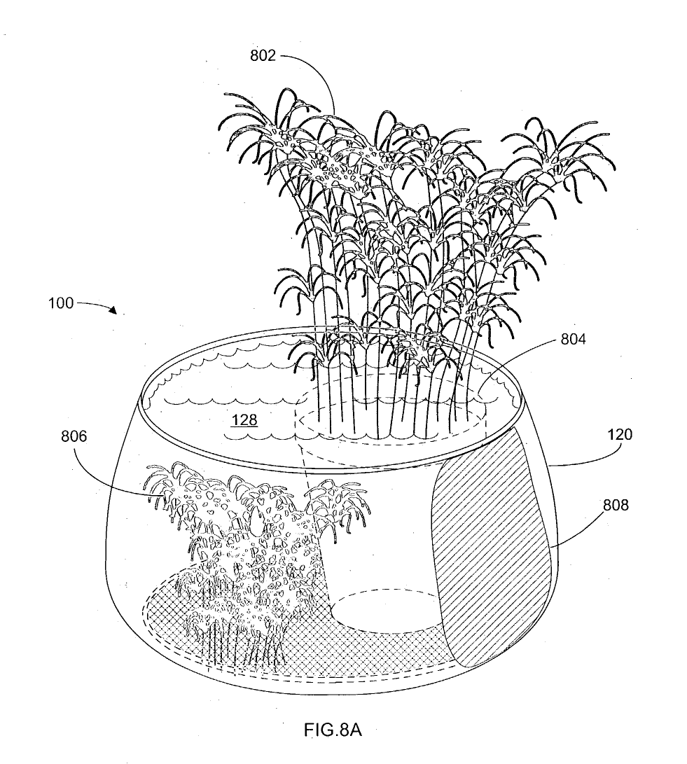

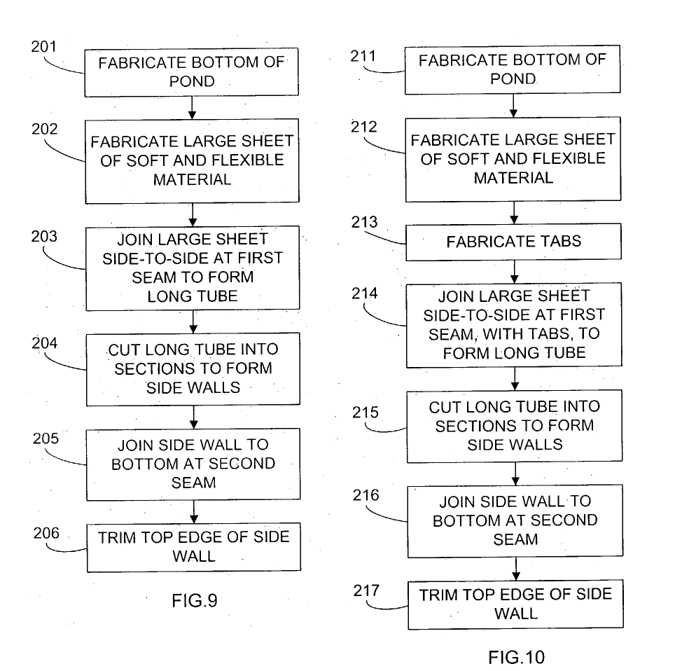

FIG. 9 is a flow chart depicting steps that may be performed to fabricate a decorative pond container 100. In step 201, a bottom portion of a decorative pond is fabricated of waterproof material, preferably as a circular element. Alternatively, step 201 can be performed concurrently with one or more of the following steps 202-204, or can be performed at any time prior to step 205. In step 202, a large sheet of soft and flexible, waterproof material is fabricated in dimensions appropriate for subsequent steps. In particular, the width is preferably somewhat greater than a desired circumference of the finished pond container 100. The length is preferably somewhat greater than a multiple of a desired depth of the finished pond container 100. In step 203, the large sheet of soft and flexible, waterproof material is joined side to side at a first seam 122 to form a tube having a circumference substantially equal to the desired diameter of the finished pond container 100. The seam 122 can be joined using a heat-seal process, a sonic weld, an adhesive or other process suitable for creating a water-tight seal. In step 204, the tube is cut into sections, each section having a length substantially equal to a desired depth of the finished pond container 100 and forming a side wall 120 of the pond container. In step 205, the side wall 120 is joined to the bottom 110 at another seam 124, again using a heat-seal process, a sonic weld, an adhesive or other suitable process. In step 206, the top edge 126 of the side wall 120 is trimmed with a flexible material using the same or similar process.

FIG. 10 is a flow chart depicting an alternate series of steps that may be performed to fabricate a decorative-pond container 100. In step 211, a bottom portion of a decorative pond is fabricated of waterproof material, preferably as a circular element. Alternatively, step 211 can be performed concurrently with one or more of the following steps 212-215, or can be performed at any time prior to step 216. In step 212, a large sheet of soft and flexible, waterproof material is fabricated in dimensions appropriate for subsequent steps. In particular, the width is preferably somewhat greater than a desired circumference of the finished pond container 100. The length is preferably somewhat greater than a multiple of a desired depth of the finished pond container 100. In step 213, one or more retainers 136-138 are fabricated as tabs, small loops, or the like for securing a small-diameter piece of tubing and/or a power cord. Alternatively, step 213 can be performed concurrently with one or more of steps 211 or 212, or at any time prior to step 214. In step 214, the large sheet of soft and flexible, waterproof material is joined side to side at a first seam 122 to form a tube having a circumference substantially equal to the desired diameter of the finished pond container 100 with one or more retainers 136-138 also joined at the seam 122. The seam 122 may be joined using a heat-seal process, a sonic weld, an adhesive or other process suitable for creating a water-tight seal. In step 215, the tube is cut into sections, each section having a length substantially equal to a desired depth of the finished pond container 100 and forming a side wall 120 of the pond container. In step 216, the side wall 120 is joined to the bottom 110 at another seam 124, again using a heat-seal process, a sonic weld, an adhesive or other suitable process. In step 217, the top edge 126 of the side wall 120 is trimmed with a flexible material using the same or similar process.

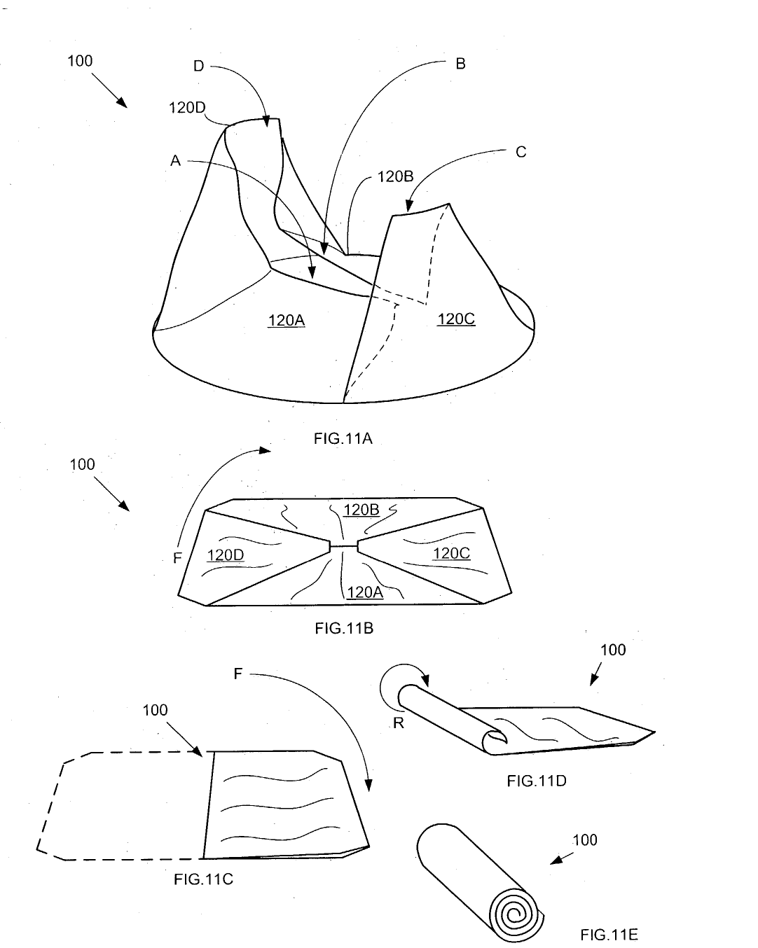

FIGS. 11A through 11E depict a series of steps that may be performed to collapse, fold and roll the pond container 100 for storage, packing or shipping. As shown in FIG. 11A, a first section of side wall 120, section 120A, is folded inwards in the direction of arrow A. An opposite section of side wall 120, section 120B, is folded inwards in the direction of arrow B. A third section of side wall 120, section 120C, is folded inwards in the direction of arrow C. The remaining section of side wall 120, section 120D, is folded inwards in the direction of arrow D. FIG. 11B depicts the pond container 100 collapsed as described above. The collapsed pond container 100 is then folded in half in the direction of arrow F. FIG. 11C depicts the collapsed pond container 100 folded in half in the direction of arrow F. As shown in FIG. 11D, the collapsed and folded pond container 100 may then be rolled in the direction of arrow R. FIG. 11E depicts the pond container fully collapsed, folded and rolled, ready to be secured with a rubber band or other means and placed in a carton, bag or other packaging means.

A water garden created using the pond container 100 may be installed in minutes, preferably on any level surface such as a terrace, deck, or garden. The water garden may be completed using potted aquatic plants, floating aquatic plants, fish, gravel, stones, underwater lights, and other enhancements, as desired. A translucent polymer material preferably used to fabricate the side wall 120 produces delightful images as sunlight streams through the rippling water. Shadows cast upon the side wall 120 by interior features such as plants, fish, and other enhancements further enhance the delightful images. A substantially transparent (clear) polymer material alternatively used to fabricate the side wall 120 produces fascinating views of aquatic environments contained within the water garden.

The use of the pond container 100 eliminates expensive manufacturing, packaging, and shipping costs. Difficult and expensive installation requirements such as specific excavation and supporting structure, complicated plumbing and assembly are also eliminated. The decorative pond container provides additional uses as an introduction to water gardening.

The pond container 100 may be used by itself or in combination with another pool or pond. By itself, the decorative pond container may be used as a rain barrel, or for storing plants over the winter. The decorative pond container may be used as a drinking fountain with water filtered through a plant, such as grasses, placed in a pot having successive layers of dirt, gravel and charcoal. The potted plant may sit in the decorative pond container 100 of the decorative pond container to filter water seeping through the successive layers and into the general reservoir of water within the pond.

The pond container 100 may also be used in conjunction with other ponds or pools. As a secondary pond for conditioning water, new water can be properly aerated to allow chlorine to evaporate and temperature to normalize before being transferred to a main pond. The action of the water pump forces water through the outlet spout, which should be secured in both of the internal tabs so that water sprays into the air before falling back into the pond. This action aerates the water in a well-known fashion and allows any chlorine that may be present in the water to evaporate. After a day or two, any new water added to the secondary pond will normally be at about the same temperature as water in the main pond, and properly aerated, so that water from the secondary pond can safely be transferred to the main pond.

The pond container 100 may also be used as a so-called “sick pond” for holding plants and fish while a main pond is being cleaned. Since the decorative pond container is preferably fabricated from the same vinyl material as most liners for in-ground ponds, the decorative pond container is safe for holding sensitive fish.

The pond container 100 may also be used as a rain barrel for collecting rain water and as a watering trough for watering livestock. Filled with dirt, the pond container 100 may be used as a planter for growing plants.

The method of the pond container 100 also results in a product that can easily be folded and rolled in to a small package. Since the materials from which the pond container 100 is preferably fabricated are both flexible and soft, the pond can be folded and rolled when empty without creasing or cracking the side wall, as could occur with the semi-rigid walls of certain prior swimming pools.

Having thus described the pond container 100 by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the pond container may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

I claim:

1. A pond container, comprising:
a bottom; and
one or more flexible walls extending generally upward from the bottom;
wherein said bottom and said one or more flexible walls form a container for liquid; and
wherein at least an upper portion of said flexible wall deforms outwardly to a greater extent toward the bottom when said pond container contains liquid.

2. The pond container of claim 1, wherein said flexible wall is foldable in at least two, substantially orthogonal directions.

3. The pond container of claim 1, wherein said flexible wall is formed of a polymer of substantially uniform thickness.

4. The pond container of claim 1, wherein said flexible wall is formed of polyvinyl chloride.

5. The pond container of claim 1, further comprising a submersible water pump for circulating water or creating a fountain stream within the container.

6. The pond container of claim 5, further comprising an outlet spout connected to an outlet of the pump.

7. The pond container of claim 6, further comprising retainers attached to said wall for supporting said outlet spout.

8. The pond container of claim 1, further comprising a decorative liner inserted onto said bottom.

9. The pond container of claim 8, wherein at least a portion of said decorative liner is supported above said bottom, providing a space for secluding at least a portion of a water pump from view.

10. The pond container of claim 1, further comprising a rigid decorative liner forming at least a portion of said bottom.

11. A container, comprising:
a bottom;
a flexible side wall extending upwardly from the bottom forming an interior section for containing a liquid, the flexible side wall being inwardly collapsible when the container is empty of liquid; and
wherein head pressure from liquid contained by the side wall prevents the side wall from collapsing inwardly.

12. The container of claim 11, wherein said side wall is formed of a translucent or transparent material.

13. A method of constructing a container for holding a pond, comprising the steps of:
fabricating a bottom from a waterproof material;
fabricating a side wall from a flexible, waterproof material; and
joining said side wall to said bottom to form a waterproof seal.

14. The method of claim 13, further comprising the step of forming a pond within the container by placing a quantity of liquid in said container, wherein said side wall yields to head pressure of said liquid, deforming into an outwardly curved shape under the influence of said head pressure.

15. The method of claim 13, wherein the step of fabricating a side wall further joining together opposite ends of a sheet of material at a waterproof seam to form said side wall.

16. The method of claim 13, further comprising the step of joining at least one retainer to said side wall.

17. The method of claim 13, wherein the step of fabricating said side wall further comprises forming said side wall from a translucent material.

18. The method of claim 13, wherein the step of fabricating said side wall further comprises forming said side wall from a substantially transparent material.

19. The method of claim 13, wherein the step of fabricating said side wall further comprises forming said soft and flexible, waterproof material from a polymer.

20. The method of claim 19, wherein the step of fabricating said side wall further comprises forming said polymer from polyvinyl chloride.

21. A container, comprising:
a bottom;
a flexible side wall extending up from the bottom forming an interior section for containing a liquid; and
wherein said flexible side wall deforms outwardly toward the bottom in response to pressure from liquid contained by the side wall within the container.

22. The pond container of claim 21, wherein said pressure of said liquid supports said flexible side wall.

23. The pond container of claim 21, wherein at least a portion of said side wall deforms outwardly into a curved shape in response to head pressure of said liquid.

24. The pond container of claim 23, wherein the head pressure gradient of said liquid outwardly expands at least a portion of said side wall into varying radii of curvature.

25. A container for holding a liquid, comprising:
a bottom surface that is substantially flat when the container is unfilled with liquid;
an expandable side wall extending upwardly from the bottom surface;
wherein at least a portion of the expandable side wall stretches to form an outwardly extending bulge under the pressure of liquid held by the container; and
wherein at least a portion of the side wall forming the bulge is vertically supported by the head pressure of liquid held by the container.

26. A container for holding liquid, comprising:
a flexible bottom;
a flexible side wall extending upwardly from the bottom for containing a liquid;
wherein the bottom and side wall can each be folded and unfolded at any location along fold lines running in two or more directions without damage; and
wherein the side wall is upwardly and outwardly supported by the pressure of liquid held by the container.

27. A container for holding liquid, comprising:
a bottom;
a side wall extending upwardly from the bottom and forming an outward bulge under the pressure of liquid held by the container;
wherein the apex of outward curvature of the side wall is closer to the bottom than to the top perimeter of the side wall; and
wherein the pressure of liquid held by the container prevents at least a portion of the side wall above the bulge apex from collapsing under its own weight.

28. A container for holding a liquid, comprising:
a container side wall formed of material expandable outwardly in correlation to the amount of head pressure applied against the side wall from liquid held by the container;
wherein at least a portion of the container side wall expands outwardly to a greater extent as the head pressure against the side wall increases with the depth of liquid held by the container; and
wherein the outward expansion of the side wall as as the depth of liquid held by the container increases causes the side wall inner surface to face more downwardly than when the container is unfilled and causes the inner surface to receive vertical support from the head pressure of the liquid.

29. A container for holding liquid, comprising:
a container bottom;
a side wall of expandable material extending upwardly from and secured to the container bottom, the side wall expanding outwardly to a greater extent as the depth of liquid within the container increases; and
wherein the container bottom resists outward expansion of the side wall, forming a bulge in the side wall having an apex near the bottom of the container.
